(19) United States
(12) Patent Application Publication
(10) Pub. No.: US 2026/0203054 A1
(43) Pub. Date: Jul. 16, 2026

(54) TEXT TO DATABASE

(71) Applicant: ServiceNow, Inc., Santa Clara, CA (US)

(72) Inventors: Satish Kumar Kanikaram, Hyderabad (IN); Sujit Kumar Sharma, Hyderabad (IN); Vignesh Iyer, Ahmedabad (IN); Harish Tati, Vijayawada (IN); Raj Kumar Sanganabatla, Hyderabad (IN); Ashok Pandiyan Alagesan, Coimbatore (IN)

(21) Appl. No.: 19/021,806

(22) Filed: Jan. 15, 2025

(51) Int. Cl. G06F 8/71; G06F 16/22

(52) U.S. Cl. CPC G06F 8/71; G06F 16/2282

(57) ABSTRACT

Embodiments of the subject technology relate to systems, methods, and computer-readable media for software component development. Specifically, metadata associated with a table in a database system is obtained. The metadata can comprise a table identifier and one or more synonyms associated with the table identifier. A request for a specific table associated with an entity can be received. Whether the specific table satisfied a similarity criterion with respect to the metadata can be determined. In response to determining the similarity criterion is satisfied, the entity can be provided access to the existing table.

### BACKGROUND

### 1. Technical Field

The present disclosure generally relates to software component development, and more specifically to developing a software component from an existing table based on metadata associated with the table.

### 2. Introduction

Management of operations in a database system can be complicated, such as the creation of new software components that are associated with or otherwise utilize the database system. For example, tables in the database system can be used in creating new software components, e.g., plugins for existing software application. Such tables can already exist in the database system and be shared across different software components that are developed in association with the database system.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture 200 for maintaining a software component from an existing table based on metadata associated with the table, in accordance with some examples of the present disclosure;

FIG. 3 illustrates a flowchart of an example method of maintaining a software component from an existing table based on metadata associated with the table, according to some examples of the present disclosure;

FIG. 4 illustrates a flowchart of an example method of providing access to an existing table or creating a requested table based on similarity criterion with metadata of the existing table, according to some examples of the present disclosure;

FIG. 5 illustrates a flowchart of an example method of automatically identifying a table used in creating a software component and providing an entity access to an existing table for creating the software component, according to some examples of the present disclosure;

FIG. 6 is an example of a deep learning neural network that can be used to implement all or a portion of the systems and techniques described herein, according to some examples of the present disclosure;

FIG. 7 is a diagram illustrating an example architecture of an example transformer model, according to some examples of the present disclosure; and

FIG. 8 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Management of create, read, update, and delete operations in a database system can be complicated, such as the creation of new software components that are associated with or otherwise utilize the database system. For example, tables in the database system can be used in creating new software components, e.g., plugins for existing software application. Such tables can already exist in the database system and be shared across different software components that are developed in association with the database system. However, the database system lacks a mechanism for efficiently determining whether a new software component uses an existing table in the database. A human can manually check whether a specific table in the database system can be used in developing a new software component; however, a human who can perform this task can require years of experience in software development, e.g. in relation to the database system. Further, such manual checking can be time consuming and inaccurate.

With respect to identifying whether existing tables can be used in developing a new software component, discrepancies in table naming and description conventions can make it difficult to determine whether the existing tables meet the requirements for the new software component in a more automated manner. For example, a first entity can title a table with the word “supplier.” Further in the example, a second entity, in developing a new software component, can require a table that is associated with a “manufacturer,” as referenced by the second entity. In turn, an automated process can overlook that the table of the first entity could be used in developing the new software component of the second entity because the words “supplier” and “manufacturer” do not exactly match, even though the semantic meaning of the words are similar. As a result, a new table can be created for the second entity when the supplier table of the first entity could have been used by the new software component, effectively wasting resources by recreating the same table.

The disclosed technology addresses the foregoing by maintaining a metadata table for a table in a database system. The metadata table can comprise synonyms associated with a name of the table in a database system. Further, a request for a specific table in developing a new software component can be received and the specific table can be compared to the information in the metadata table to determine if the existing table can be used in developing the software component. As a result, a table that is already present in the database system can be reused without recreating the same table. This can eliminate the need to recreate the table for each new software component that uses the table from the database system, thereby conserving computational resources. This can be done in an automated matter thereby eliminating the need for manual matching of table requirements to existing tables through an experienced human. Further, matching based on metadata of the existing table, e.g. synonyms, can decrease the chances that an existing table will be unnecessarily duplicated in developing the new software component.

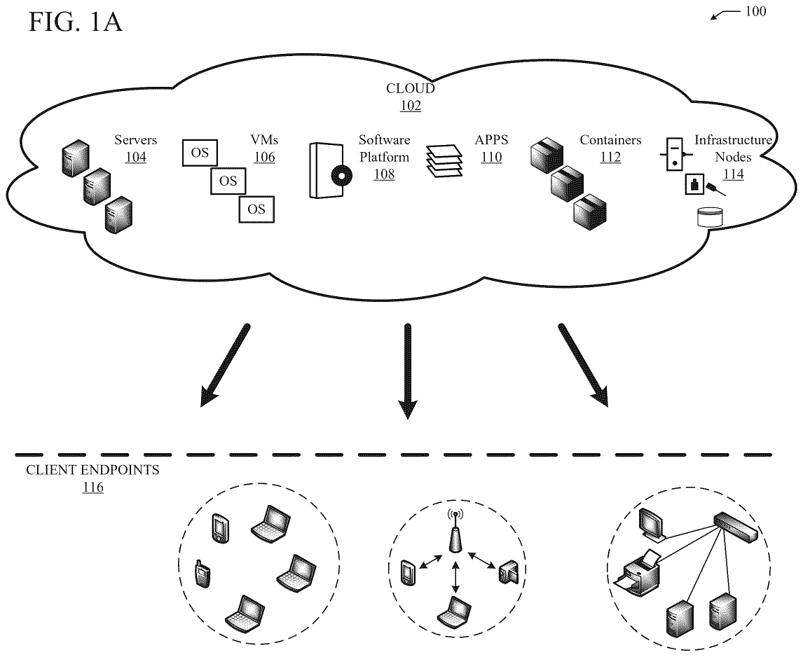

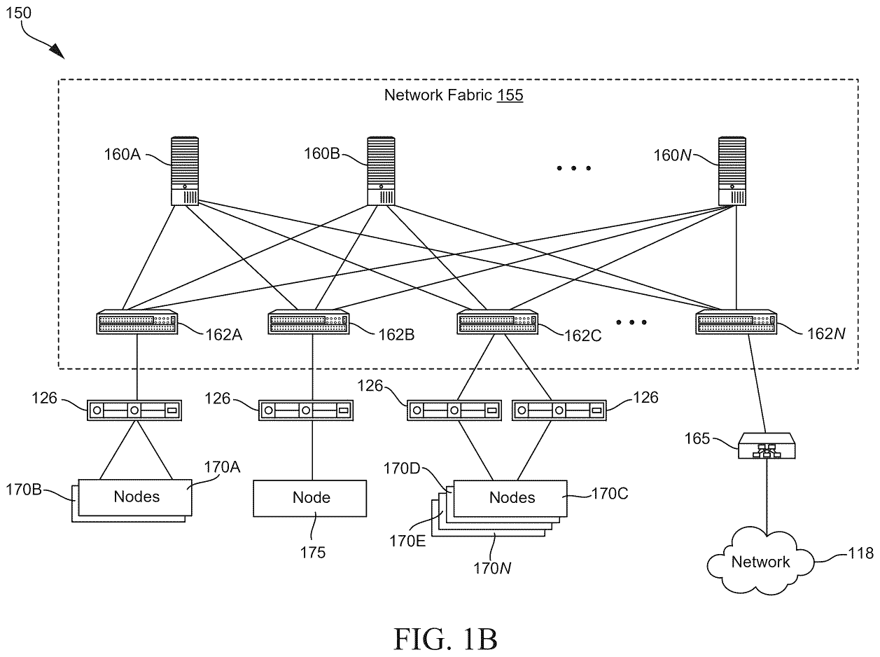

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

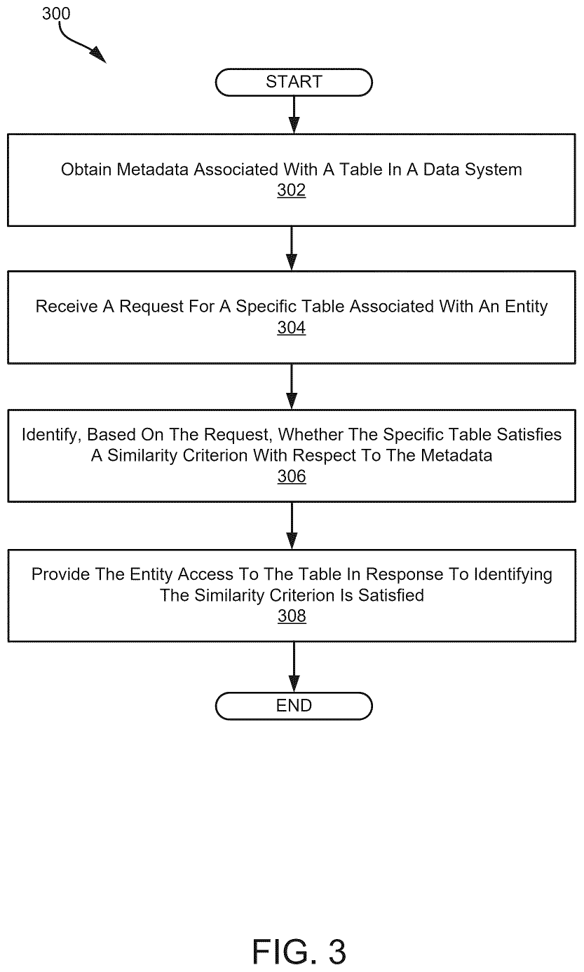

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, machine learning (ML) models and large language models (LLMs) and other applicable models and applications can be implemented through the architectures 100 and 150.

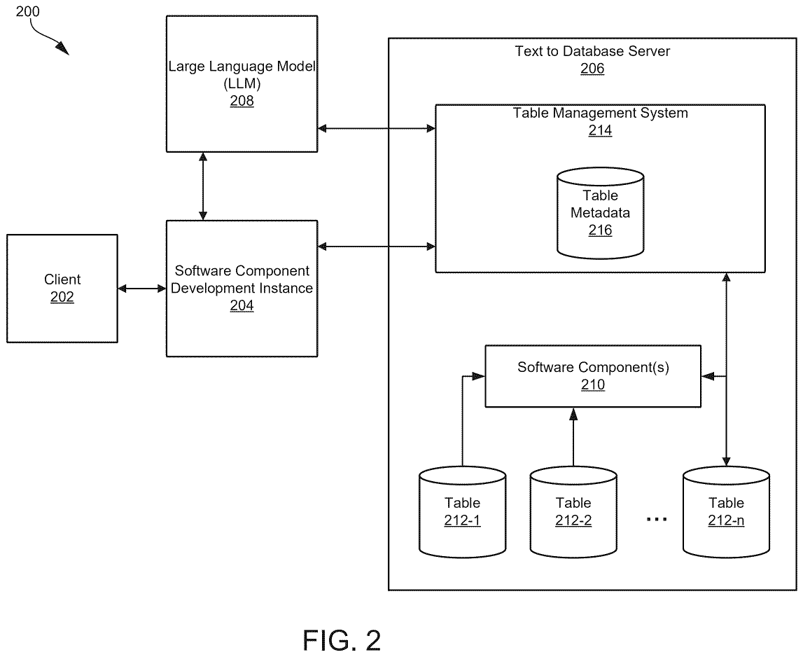

FIG. 2 illustrates a schematic diagram of an architecture 200 for maintaining a software component from an existing table based on metadata associated with the table, in accordance with some examples of the present disclosure. The architecture 200 comprises a client 202, a software component development instance 204, a text to database server 206, and an LLM 208.

The client 202 functions as an applicable device that can interact with the software component development instance 204 in developing or modifying a software component. Specifically, the client 202 can request services from the text to database server 206 through the software component development instance 204 for developing or modifying a software component. A software component, as used herein, can comprise one or more software units of a software architecture that can be executed to perform specific functionality.

The software component development instance 204 is created for a developer and can be used by the developer to create a new software component or modify an existing software component, otherwise referred to as maintaining a software component. Specifically, the software component development instance 204 can provide functionality to a developer for maintaining a software component. In providing functionality for maintaining a software component, the software component development instance can interact, e.g. receive input from and provide output to, the developer through the client 202. Specifically, the software component development instance 204 can receive input with a description of a specific software component that the developer wants to create. A description of a software component, for purposes of maintaining the software component, can include applicable characteristics, explanations, and requirements for the software component in both development and execution of the software component. For example, the description can indicate that the developer wants to create a specific plugin for performing a specific workflow based on a group of vendors.

The software component development instance 204 can aid the developer in maintaining the software component. Specifically, the software component development instances 204 can receive input indicative of user intent regarding the development of the software component. As follows, the software component development instance 204 can identify a table and other units of software that are needed to develop the software component. For example, the developer can input a desire to a create a software component for monitoring vendor tasks based on names and descriptions. As follows, the software component development instance 204 can identify a specific table that is needed to develop the software component based on the input.

The LLM 208 can be an applicable generative artificial intelligence (AI) model that can receive a prompt and make an inference based on the prompt. Specifically, the LLM 208 can perform natural language processing tasks based on a prompt to generate an inference. In various embodiments, the LLM 208 can receive a prompt from the software component development instance 204 and make an inference based on the prompt. Specifically, the software component development instance 204 can generate a prompt based on user input regarding maintenance of a software component. In turn, the LLM 208 can infer a response that can be used in maintaining the software component. For example, the LLM 208 can receive a response indicative of intent of a developer in creating a new plugin. As follows, the LLM 208 can infer characteristics of one or more tables, including table names, column names, and column descriptions, that can be used by the new plugin. The characteristics of the one or more tables can then be returned to the software component development instance 204 for further facilitating development of the new plugin.

In the example architecture 200 shown in FIG. 2, the text to database server 206 can provide functionality to the software component development instance 204 in either or both accessing existing tables and creating new tables. Specifically, the text to database server 206 can provide functionality to the software component development instance 204 in accessing tables for maintaining software components, e.g. through the client 202. For example, the text to database server 206 can provide the software component development instance 204 access to an existing table for purposes of developing a new software component.

The text to database server 206 comprises existing software component(s) 210 and associated tables 212-1, table 212-2 . . . table 212-n (collectively referred to as tables 212). The software component(s) 210 can comprise a component that was developed for a specific entity that is associated with the text to database server 206. As follows, the tables 212 can comprise a table that is specifically used in the execution of the component that was developed for the specific entity. For example, one of the software component(s) 210 can comprise a plugin for accessing supplier information for a customer. As follows, one of the tables 212 can include names, locations, addresses, and bank account numbers of suppliers for the customer.

The text to database server 206 comprises a table management system 214. The table management system 214 functions to maintain tables in the text to database server 206. For example, the table management system 214 can add a newly created table to the text to database server 206. Further, the table management system 214 functions to control access, e.g. by the software component development instance 204, to the tables 212 maintained at the text to database server 206. For example, the table management system 214 can provide the software component development instance 204 access to one or more of the tables 212, e.g. as part of maintaining a software asset.

The table management system 214 comprises table metadata 216 of the tables 212 that are maintained at the text to database server 206 and accessible through the text to database server 206. Metadata 216 of the tables 212 can comprise application information describing characteristics of the tables 212 themselves and data contained in the tables 212. For example, metadata 216 of a table can comprise a table identifier, one or more synonyms associated with the table identifier, and a reference of the table, e.g. a location from which the table can be retrieved in the table management system 241. A table identifier can comprise a table name or other applicable title of the table that can be used in identifying the table, e.g. in a natural language. Synonyms associated with a table identifier can comprise words, phrases, abbreviations, or applicable elements of natural language that have the same or similar semantic meaning as words, phrases, abbreviations, or applicable elements of natural language included in the identifier. For example, a table name can include the word “manufacturer” and synonyms can include “supplier,” “vendor,” or other applicable words, phrases, abbreviations, or elements of natural language that have the same or similar semantic meaning to “manufacturer.”

The metadata 216 can be in the form of a metadata table. Specifically, the metadata table can be titled “table synonyms” and comprise a cell comprising the words “table identifier” and a corresponding cell that is a string that comprises the table identifier, a cell comprising the word “synonyms” and a corresponding cell that is a string that comprises the synonyms separated by commas. The metadata table can also comprise a cell comprising the words “reference” and a corresponding cell that includes a reference to the table that is the subject of the metadata table.

Metadata 216 can be generated by an applicable source. Specifically, an entity associated with creating any of the tables 212 can provide metadata describing the tables 212. More specifically, a developer of a software component for which a table is defined can provide synonyms for the table identifier of the table. For example, a table owner can be queried to provide a list of possible scenarios that the table can be used for, scenarios that the table should not be used for, and other synonyms or metadata for the table.

Metadata 216 for the tables 212 can be generated by the LLM 208. Specifically, the LLM 208 can receive data regarding characteristics of the tables 212 and/or the software component(s) 210. As follows, the LLM 208 can generate the metadata 216 for the tables 212 based on the received data. The table management system 214 can generate a prompt for the LLM 208 for inferring the metadata 216. The prompt can provide applicable information describing a table including a table identifier for the table and other characteristics of the table and information included in the table. The prompt can also instruct the LLM 208 to infer synonyms for the table identifier of the table, otherwise synonyms associated with the table identifier, that can be included in the metadata 216 for the table.

The table management system 214 can receive a request for a specific table from the software component development instance 204. The request can be sent from the software component development instance 204 functioning to aid a developer in maintaining a software asset, e.g. modifying an existing software asset or creating a new software asset. The table that is the subject of the request can be used by the software component that is maintained by the software component development instance 204. For example, the request can be for a table that is used by a new plugin being developed through the software component development instance 204. The request can include applicable information describing the table. For example, the request can include a name of a new table and descriptions of the information to include in the new table.

The table management system 214 can use a received request to identify whether a table that is the subject of the request is one of the tables 212 available at the text to database server 206. In turn, if the table management system 214 identifies that the requested table matches one of the tables 212, then the table management system 214 can facilitate access by the software component development instance 204 to the matching table. Alternatively, if the table management system 214 identifies that the requested table does not match one of the tables 212, then the table management system 214 can create or facilitate creation of the requested table. In turn, the newly created table can be stored at the text to database server 206 and potentially be used in future software component maintenance, e.g. development.

The table management system 214 can identify whether the table matches the tables 212 at the text to database server 206 based on the table metadata 216 for the tables 212. Specifically, the table management system 214 can identify, based on information included in the request whether the requested table satisfies a similarity criterion with respect to the metadata. A similarity criterion can include an applicable measure through which it can be determined whether a requested table matches one of the tables 212 in the text to database server 206 based on the table metadata 216. Specifically, a similarity criterion can comprise whether characteristics of all or portions of a table identifier, e.g. table title, match synonyms associated with a table identifier of one of the tables 212. Such matching can define the similarity criterion and comprise whether there is an exact match with the synonyms or matching within a threshold degree. For example, if a word in a title of a requested table matches a synonym of table 212-1 in the table metadata 216, then the table management system 214 can determine that the table 212-1 can be used to satisfy the request. As follows, the table management system 214 can provide the software component development instance 204 access to the table 212-1, e.g. for developing a new software component.

FIG. 3 illustrates a flowchart 300 of an example method of maintaining a software component from an existing table based on metadata associated with the table, according to some examples of the present disclosure. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method. The modules will be discussed with respect to the example architectures described herein.

At module 302, metadata associated with a table in a data system is obtained. The metadata can be obtained from an entity associated with the table. Further, the metadata can be obtained from an LLM. Using an LLM to obtain the metadata of the table is technically advantageous as it can provide increased data richness to the metadata, as opposed to relying on just a human to provide the metadata. In turn, such improved data richness can facilitate more accurate matching of requested tables to already existing tables based on the metadata. For example, an LLM can obtain metadata associated with different sources, enabling a variety of type of metadata to be used for matching.

At module 304, a request for a specific table associated with an entity is received. The request can be for creating a new table for developing a new software asset or for modifying an existing software asset. The request can be received from a software asset development instance that is interacting with a client and include applicable characteristics of the table. For example the request can include a description of the requested table, including a description of the information to include in the requested table, and a table identified of the requested table.

In various embodiments, the request can be created as part of an automated technique for maintaining a software asset. Specifically, the table that is the subject of the request can be identified through an LLM as part of an automated technique for maintaining a software asset, e.g. generating a new software asset. As follows, the request itself can be generated by the LLM. Having the LLM generate the request is technically advantageous as the LLM can improve the accuracy of the description of the table that is used in maintaining a software asset. This can lead to an increased chance that the requested table is accurately matched to an existing table. Further, having the LLM generate the request is technically advantageous as the LLM can help in ensuring that the requested table is the actual table that is needed in developing the software asset.

At module 306, it is identified, based on the request, whether the specific table satisfies a similarity criterion with respect to the metadata. The similarity criterion can be defined based on a degree of similarity between the table that is the subject of the request and the metadata associated with the table stored in the data system. For example, if the characteristics of the requested table match, e.g. withing a specific degree, one or more synonyms for the existing table, as include in the metadata for the existing table, then it can be found that the similarity criterion is satisfied.

At module 308, the entity is provided access to the table in response to identifying the similarity criterion is satisfied. Specifically, the entity can be provided access to the table while refraining from creating the requested table. Providing access to the table while refraining from creating the table is technically advantageous as the software asset can be maintained while saving computational resources that would otherwise be used to create the requested table, e.g. duplicate the existing table. Further, using metadata to match a requested table to an existing table is technically advantageous as an existing table does not have to be analyzed in depth, e.g. in its entirety, to determine if it matches a requested table. In turn, this can eliminate, at least in part, the need to use a human with years of experience in application development to analyze the vast number of existing tables in trying to find a match to an existing table. As follows, the speed at which a requested table can be matched to an existing table can be greatly increased.

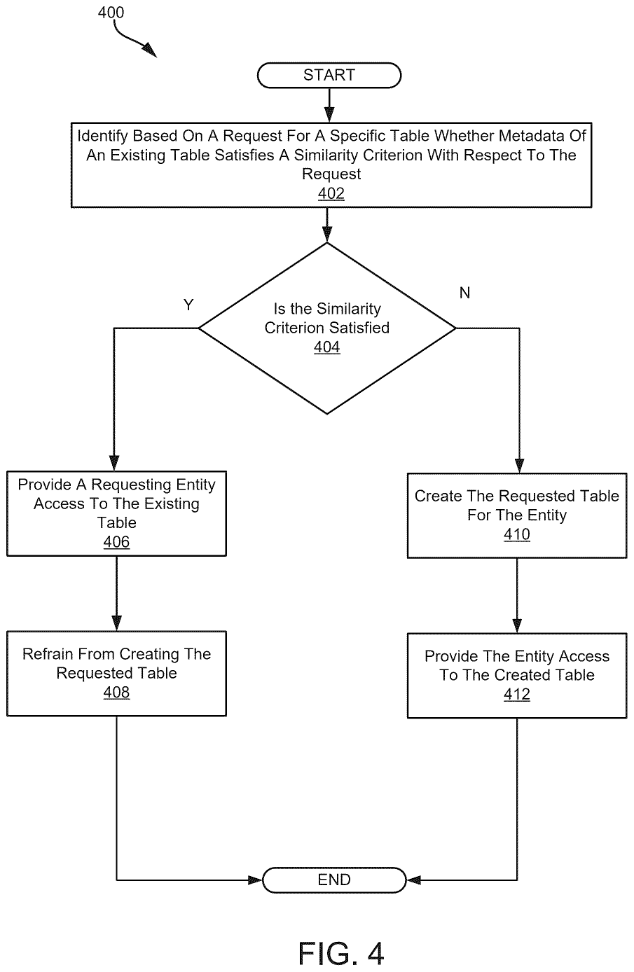

FIG. 4 illustrates a flowchart 400 of an example method of providing access to an existing table or creating a requested table based on similarity criterion with metadata of the existing table, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, it is identified whether metadata of an existing table satisfies a similarity criterion with respect to a request for a specific table. Specifically, the metadata can comprise synonyms of a table identifier of an existing table. As follows, the synonyms can be compared to a table identifier or other applicable characteristics describing the requested table. Whether the similarity criterion is met can depend on whether one or more synonyms of the table identifier of the existing table match the table identifier or characteristics of the requested table, e.g. either exactly or to a degree. At decision point 404 it is determined whether the similarity criterion is met.

If it is determined that the similarity criterion is met, then the flowchart 400 continues to module 406 where a requesting entity is provided access to the existing table. As follows, at module 408, the requested table is not created for the requesting entity. The existing table can be used in maintaining a software component. For example, the existing table can be used in developing a new software component. Using an existing table instead of creating a new table in developing a new software component, is technically advantageous in that it conserves computational resources and data storage space.

If, at decision point 404, it is determined that the similarity criterion is not met, then the flowchart 300 continues to module 410 where the requested table is created’ for the entity. As follows, at module 412, the entity is provided access to the created table. The created table can then be stored on a data system. As follows the created tables can be used in the maintenance of other software components, e.g. new software components. Specifically, metadata can be generated for the created table and the metadata can then be used to match a requested table to the newly created table.

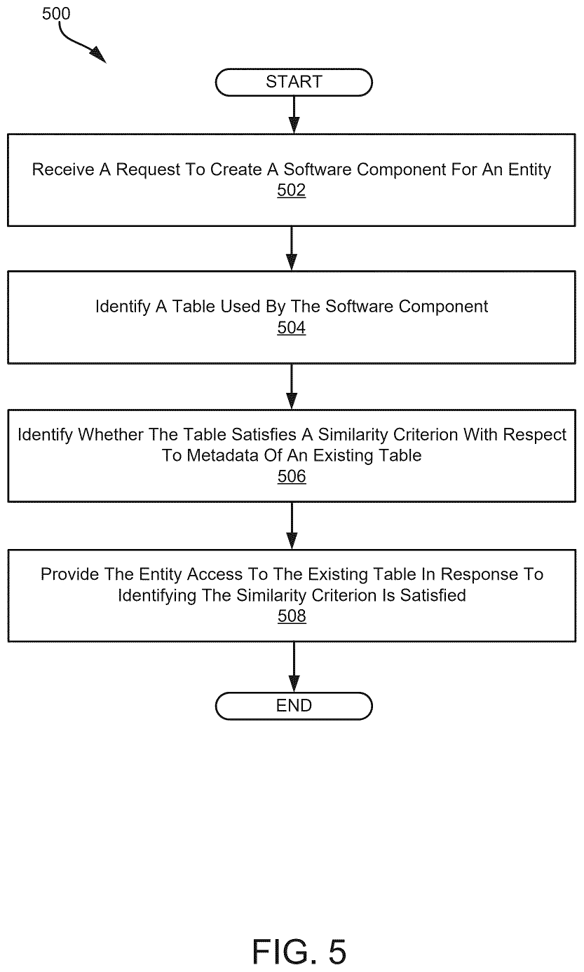

FIG. 5 illustrates a flowchart 500 of an example method of automatically identifying a table used in creating a software component and providing an entity access to an existing table for creating the software component, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, a request to create a software component for an entity is received. The request to create the software component can be received at a software component development instance. Specifically, an entity can input characteristics of a software component to be developed. For example, an entity can input parameters for a plugin for accessing data associated with a certain type of manufacturer.

At module 504, a table used by the software component is identified. The table can be identified through an automated or semi-automated process. Specifically, the table can be identified through an automated or semi-automated process based on the characteristics of the software component that are input by the entity. For example, an LLM can identify, based on the software component characteristics, what table will be used in executing the software component and define characteristics for the table. Automatically or semi-automatically identifying a table, e.g. through an LLM, is technically advantageous, as it can save resources of a human developer having to identify what table is needed for developing the software component. Further, this can improve the functioning of the software component itself by helping to ensure that the correct table is identified and subsequently used in developing the software component.

At module 506, it is identified whether the table satisfies a similarity criterion with respect to metadata of an existing table. Specifically, it can be determined whether a table identifier for the identified table matches, e.g., within a threshold or exactly, one or more synonyms associated with a table identified of the existing table. As follows, if it is found that the table identifier of the identified table matches the one or more synonyms, then it can be determined that the similarity criterion is satisfied.

At module 508, the entity is provided access to the existing table in response to identifying the similarity criterion is satisfied. Specifically, a software component development instance can be given access to the existing table. In turn, the software component can be developed in the instance using the existing table.

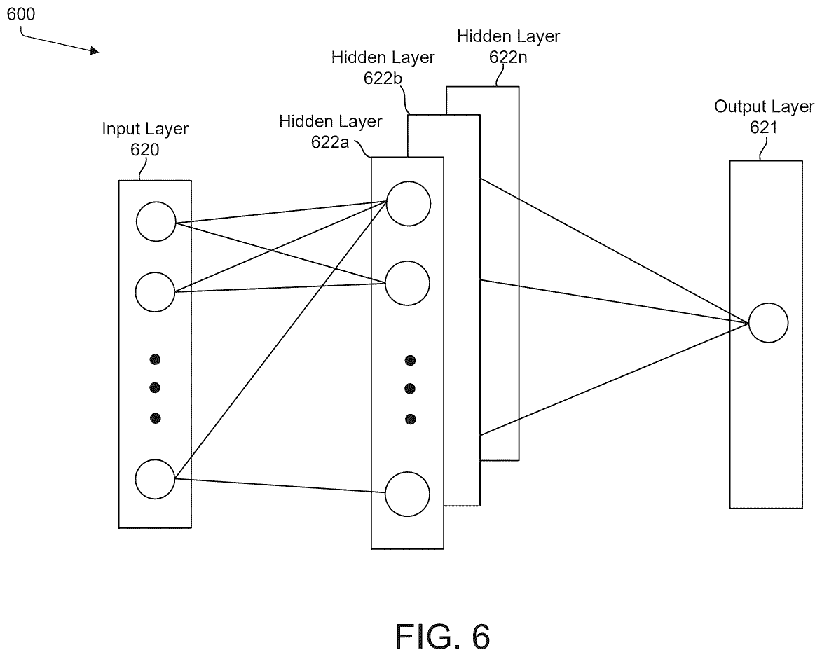

In FIG. 6, the disclosure now turns to a further discussion of models that can be used to implement the technology described herein. FIG. 6 is an example of a deep learning neural network 600 that can be used to implement all or a portion of the systems and techniques described herein, according to some examples of the present disclosure. An input layer 620 can be configured to receive sensor data and/or data relating to an environment surrounding an AV. Neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. Neural network 600 further includes an output layer 621 that provides an output resulting from the processing performed by the hidden layers 622a, 622b, through 622n.

Neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)\textcircled{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

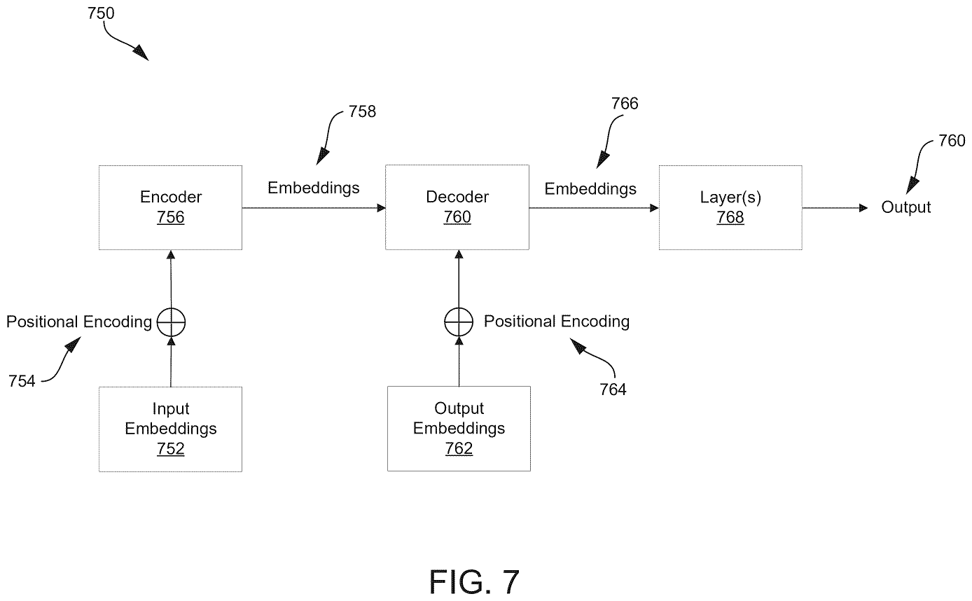

FIG. 7 is a diagram illustrating an example architecture of an example transformer model 750, according to some examples of the present disclosure. The transformer model 750 can be used to implement an LLM that can be used to implement the technology described herein. As shown, the transformer model 750 can include input embeddings 752 used as inputs to the transformer model 750. The input embeddings 752 can include input values representing words and/or sentences, such as numbers or vectors representing words and/or sentences.

In some cases, the input embeddings 752 can function like a dictionary that helps the transformer model 750 understand the meaning of words by placing them in an embedding space where similar words are located near each other. In some examples, the input interface 134 can be trained and/or configured to create the input embeddings 752 so that similar vectors represent words with similar meanings. In some examples, the transformer model 750 can additionally or alternatively learn to create and/or process the input embeddings 752 during training.

The transformer model 750 can use positional encoding 754 to encode the position of each word in an input sequence from the input embeddings 752 as values such as a set of numbers, a vector, etc. The values generated by the positional encoding 754 can be fed into the transformer model 750 along with the input embeddings 752. By incorporating the positional encoding 754 into the transformer model 750, the transformer model 750 can more effectively understand the order of words in a sentence and generate grammatically correct and semantically meaningful output.

The transformer model 750 can include an encoder(s) 756 used to process the positionally encoded input embeddings 752 and generate embeddings 758. The encoder(s) 756 can be part of the transformer model 750 that processes input text and generates hidden states that capture the meaning and context of the text. For example, the encoder(s) 756 can include a feed-forward neural network that is part of the transformer model 750. In some examples, the encoder(s) 756 can implement multiple encoder layers. In some cases, the encoder(s) 756 can first tokenize the input text into a sequence of tokens, such as individual words or subwords. The encoder(s) 756 can then apply one or more self-attention layers, which can generate hidden states that represent the input text at different levels of abstraction. In this way, the encoder(s) 756 can generate the embeddings 758 (e.g., a vector, a set of values, etc.) representing the semantics and position of words in one or more sentences.

The transformer model 750 can include output embeddings 762, which can include values representing words and/or sentences, such as numbers or vectors representing words and/or sentences. The output embeddings 762 can be similar to the input embeddings 752 and can also be processed by positional encoding 764 to encode the position of each word in a sequence from the output embeddings 762 as values such as a set of numbers, a vector, etc., which helps the transformer model 750 understand the order of words in a sentence. The output embeddings 762 can be used during a training phase of the transformer model 750 and can be used during an inference phase. During training, a loss function can be computed based on the output embeddings 762 and used to update the model parameters to improve the accuracy of the transformer model 750. During an inference phase, the output embeddings 762 can be used to generate the output text by mapping the predicted probabilities determined by the transformer model 750 for each token to the corresponding token in the vocabulary.

The positionally encoded input embeddings 752 (e.g., the embeddings 758) and the positionally encoded output embeddings 762 can be fed to a decoder(s) 760 used to generate the output sequence based on the encoded input sequence. During training, the decoder(s) 760 can learn how to guess the next word of a sequence by looking at the words before it. In some examples, the decoder(s) 760 can generate natural language text based on the input sequence and any learned context.

The decoder(s) 760 can generate embeddings 766 and feed the embeddings 766 to one or more network layers 768. In some examples, the one or more network layers 768 can include a linear layer and a softmax function. The linear layer can map the embeddings 766 generated by the decoder(s) 760 to a higher-dimensional space, which can transform the embeddings 766 into the original input space. The softmax function can then be applied to generate a probability distribution for each output token in the vocabulary, which can result in an output 770. In some examples, the output 770 can include output tokens with probabilities.

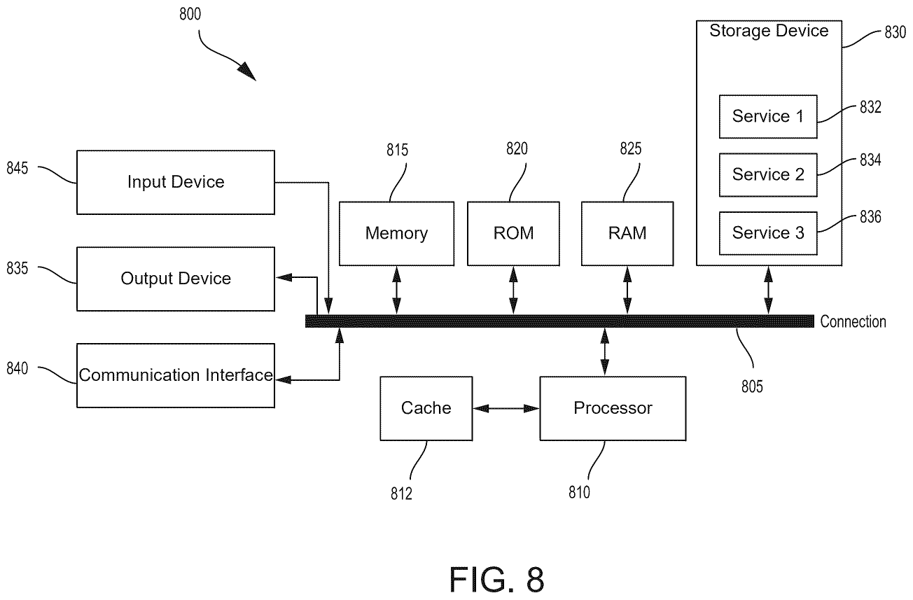

FIG. 8 illustrates an example processor-based system with which some embodiments of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative Examples of the Disclosure Include:
Embodiment 1. A computer-implemented method comprising: obtaining metadata associated with a table in a database system, the metadata comprising a table identifier and one or more synonyms associated with the table identifier; receiving a request for a specific table associated with an entity; determining, based on the request, whether the specific table satisfies a similarity criterion with respect to the metadata; and in response to determining the similarity criterion is satisfied, providing the entity access to the table.
Embodiment 2. The computer-implemented method of Embodiment 1, wherein the table identifier is a table name.
Embodiment 3. The computer-implemented method of either of Embodiments 1 or 2, wherein the metadata comprises a metadata table with entries comprising the table identifier and the one or more synonyms.
Embodiment 4. The computer-implemented method of any of Embodiments 1 through 3, further comprising refraining from creating the specific table for the entity while providing the entity access to the table in response to identifying the similarity criterion is satisfied.
Embodiment 5. The computer-implemented method of any of Embodiments 1 through 4, further comprising creating the specific table for the entity in response to identifying that the similarity criterion is not satisfied.
Embodiment 6. The computer-implemented method of any of Embodiments 1 through 5, wherein the specific table is for developing a software component associated with the entity, the method further comprising: identifying that the software component utilizes the specific table; and generating the request for the specific table as part of a create operation associated with developing the software component for the entity.
Embodiment 7. The computer-implemented method of Embodiment 6, wherein the specific table is identified by prompting a large language model (LLM) in association with developing the software component for the entity.
Embodiment 8. The computer-implemented method of any of Embodiments 1 through 7, wherein the metadata associated with the table is identified by prompting an LLM.
Embodiment 9. The computer-implemented method of Embodiment 8, wherein the one or more synonyms are identified through the LLM.
Embodiment 10. The computer-implemented method of any of Embodiments 1 through 9, wherein the one or more synonyms are identified through input from an entity associated with the table.
Embodiment 11. The computer-implemented method of any of Embodiments 1 through 10, wherein the similarity criterion comprises a degree to which an identification of the specific table matches either or both the table identifier and the one or more synonyms in the metadata.
Embodiment 12. A system comprising: one or more processors; and at least one computer-readable storage medium having stored therein instructions which, when executed by the one or more processors, cause the one or more processors to: obtain metadata associated with a table in a database system, the metadata comprising a table identifier and one or more synonyms associated with the table identifier; receive a request for a specific table associated with an entity; determine, based on the request, whether the specific table satisfies a similarity criterion with respect to the metadata; and in response to determining the similarity criterion is satisfied, provide the entity access to the table.
Embodiment 13. The system of Embodiment 12, wherein the metadata comprises a metadata table with entries comprising the table identifier and the one or more synonyms.
Embodiment 14. The system of either of Embodiments 12 or 13, wherein the instructions further cause the one or more processors to refrain from creating the specific table for the entity while providing the entity access to the table in response to identifying the similarity criterion is satisfied.
Embodiment 15. The system of either of any of Embodiments 12 through 14, wherein the instructions further cause the one or more processors to create the specific table for the entity in response to identifying that the similarity criterion is not satisfied.
Embodiment 16. The system of any of Embodiments 12 through 15, wherein the specific table is for developing a software component associated with the entity, and the instruction further cause the one or more processors to: identify that the software component utilizes the specific table; and generate the request for the specific table as part of a create operation associated with developing the software component for the entity.
Embodiment 17. The system of Embodiment 16, wherein the specific table is identified by prompting an LLM in association with developing the software component for the entity.
Embodiment 18. The system of any of Embodiments 12 through 17, wherein the metadata associated with the table is identified by prompting an LLM.
Embodiment 19. The system of any of Embodiments 12 through 18, wherein the similarity criterion comprises a degree to which an identification of the specific table matches either or both the table identifier and the one or more synonyms in the metadata.
Embodiment 20. A non-transitory computer-readable storage medium storing instructions for causing one or more processors to: obtain metadata associated with a table in a database system, the metadata comprising a table identifier and one or more synonyms associated with the table identifier; receive a request for a specific table associated with an entity; determine, based on the request, whether the specific table satisfies a similarity criterion with respect to the metadata; and in response to determining the similarity criterion is satisfied, provide the entity access to the table.
Embodiment 21. A system comprising means for performing a method according to any of Embodiments 1 through 11.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
obtaining metadata associated with a table in a database system, the metadata comprising a table identifier and one or more synonyms associated with the table identifier;
receiving a request for a specific table associated with an entity;
determining, based on the request, whether the specific table satisfies a similarity criterion with respect to the metadata; and
in response to determining the similarity criterion is satisfied, providing the entity access to the table.

2. The computer-implemented method of claim 1, wherein the table identifier is a table name.

3. The computer-implemented method of claim 1, wherein the metadata comprises a metadata table with entries comprising the table identifier and the one or more synonyms.

4. The computer-implemented method of claim 1, further comprising refraining from creating the specific table for the entity while providing the entity access to the table in response to identifying the similarity criterion is satisfied.

5. The computer-implemented method of claim 1, further comprising creating the specific table for the entity in response to identifying that the similarity criterion is not satisfied.

6. The computer-implemented method of claim 1, wherein the specific table is for developing a software component associated with the entity, the method further comprising:
identifying that the software component utilizes the specific table; and
generating the request for the specific table as part of a create operation associated with developing the software component for the entity.

7. The computer-implemented method of claim 6, wherein the specific table is identified by prompting a large language model (LLM) in association with developing the software component for the entity.

8. The computer-implemented method of claim 1, wherein the metadata associated with the table is identified by prompting an LLM.

9. The computer-implemented method of claim 8, wherein the one or more synonyms are identified through the LLM.

10. The computer-implemented method of claim 1, wherein the one or more synonyms are identified through input from an entity associated with the table.

11. The computer-implemented method of claim 1, wherein the similarity criterion comprises a degree to which an identification of the specific table matches either or both the table identifier and the one or more synonyms in the metadata.

12. A system comprising:
one or more processors; and
at least one computer-readable storage medium having stored therein instructions which, when executed by the one or more processors, cause the one or more processors to:
obtain metadata associated with a table in a database system, the metadata comprising a table identifier and one or more synonyms associated with the table identifier;
receive a request for a specific table associated with an entity;
determine, based on the request, whether the specific table satisfies a similarity criterion with respect to the metadata; and
in response to determining the similarity criterion is satisfied, provide the entity access to the table.

13. The system of claim 12, wherein the metadata comprises a metadata table with entries comprising the table identifier and the one or more synonyms.

14. The system of claim 12, wherein the instructions further cause the one or more processors to refrain from creating the specific table for the entity while providing the entity access to the table in response to identifying the similarity criterion is satisfied.

15. The system of claim 12, wherein the instructions further cause the one or more processors to create the specific table for the entity in response to identifying that the similarity criterion is not satisfied.

16. The system of claim 12, wherein the specific table is for developing a software component associated with the entity, and the instruction further cause the one or more processors to:
identify that the software component utilizes the specific table; and
generate the request for the specific table as part of a create operation associated with developing the software component for the entity.

17. The system of claim 16, wherein the specific table is identified by prompting an LLM in association with developing the software component for the entity.

18. The system of claim 12, wherein the metadata associated with the table is identified by prompting an LLM.

19. The system of claim 12, wherein the similarity criterion comprises a degree to which an identification of the specific table matches either or both the table identifier and the one or more synonyms in the metadata.

20. A non-transitory computer-readable storage medium storing instructions for causing one or more processors to:
obtain metadata associated with a table in a database system, the metadata comprising a table identifier and one or more synonyms associated with the table identifier;
receive a request for a specific table associated with an entity;
determine, based on the request, whether the specific table satisfies a similarity criterion with respect to the metadata; and
in response to determining the similarity criterion is satisfied, provide the entity access to the table.
